(19) United States
(12) Patent Application Publication
(10) Pub. No.: US 2012/0246518 A1
(43) Pub. Date: Sep. 27, 2012

(54) OPERATING A COMPUTER SYSTEM

(75) Inventors: Anne P. Francis, Winchester (GB); David E. Knibb, Hull (GB); Neil W. Leedham, Bursledon (GB); Andrew Wright, Eastleigh (GB)

(73) Assignee: INTERNATIONAL BUSINESS MACHINES CORPORATION, Armonk, NY (US)

(21) Appl. No.: 13/410,982

(22) Filed: Mar. 2, 2012

(30) Foreign Application Priority Data
Mar. 24, 2011 (EP) 11159658.1

(51) Int. Cl. G06F 11/34

(52) U.S. Cl. 714/45; 714/E11.189

(57) ABSTRACT

Trace data is periodically written to a trace table. A software trap is run. If the software trap does not fire, a run marker is set to a predefined distance behind a position of an old run marker in the trace table. The trace data is periodically written to the trace table, and, if necessary, earlier written trace table data is overwritten. Most recently written trace data is detected to have reached the run marker and the software trap is run.

### RELATED APPLICATIONS

This application claims priority to and claims the benefit of European Patent Application Serial No. EP11159658.1 titled “OPERATING A COMPUTER SYSTEM,” which was filed in the European Patent Office on Mar. 24, 2011, and which is incorporated herein by reference in its entirety.

### BACKGROUND

This invention relates to a method of operating a computer system and to the computer system itself. In one embodiment, the invention minimizes the performance impact of a service trap by optimizing its runtime frequency.

Complicated computer systems, such as a customer information control system (CICS®), have an internal trace table as well as an ability to write trace data entries out to external auxiliary storage. However, the performance overhead of writing trace data out to auxiliary storage, and the storage requirements of doing this for a sustained period, often dissuade system users from adopting this approach in a busy production environment, so that the only practical option is tracing to the internal trace table.

The CICS® internal trace table is a predefined area of storage within the CICS® address space to which CICS® writes trace records as the system operates. The performance overhead of tracing to the internal trace table is generally acceptable. However, the size of the internal trace table must be restricted. Otherwise, the table would grow so large that insufficient storage would be available for the normal production workload. An upper limit to the internal trace table size is consequently set by the user. When the trace table is full the next entry is written at the start of the table, over-writing the existing entry. In other words the trace entries wrap around the internal trace table in a cyclical manner.

### BRIEF SUMMARY

A method of operating a computer system includes periodically writing trace data to a trace table; running a software trap; if the software trap does not fire, setting a run marker a predefined distance behind a position of an old run marker in the trace table; periodically writing the trace data to the trace table, if necessary overwriting earlier written trace table data; detecting that most recently written trace data has reached the run marker; and running the software trap.

A computer system includes a trace table and a software trap and a processor programmed to periodically write trace data to the trace table; run the software trap; if the software trap does not fire, set a run marker a predefined distance behind a position of an old run marker in the trace table; periodically write the trace data to the trace table, if necessary overwriting earlier written trace table data; detect that most recently written trace data has reached the run marker; and run the software trap.

A computer program product includes a computer readable storage medium including computer readable program code, where the computer readable program code when executed on a computer causes the computer to periodically write trace data to a trace table; run a software trap; if the software trap does not fire, set a run marker a predefined distance behind a position of an old run marker in the trace table; periodically write the trace data to the trace table, if necessary overwriting earlier written trace table data; detect that most recently written trace data has reached the run marker; and run the software trap.

### BRIEF DESCRIPTION OF THE SEVERAL VIEWS OF THE DRAWINGS

Embodiments of the present invention will now be described, by way of example only, with reference to the accompanying drawings, in which:

FIG. 1 is a schematic diagram of an example of an implementation of a computer system capable of performing operations according to an embodiment of the present subject matter;

FIG. 2 is a schematic diagram of an example of an implementation of the computer system of FIG. 1 showing the use of a run marker according to an embodiment of the present subject matter;

FIG. 3 is a schematic diagram of an example of an implementation of the computer system of FIG. 1 showing the writing of trace data to the internal trace table according to an embodiment of the present subject matter;

FIG. 4 is a schematic diagram of an example of an implementation of the computer system of FIG. 1 showing the use of a second run marker according to an embodiment of the present subject matter;

FIG. 5 is a schematic diagram of an example of an implementation of the computer system of FIG. 1 showing the use of a further run marker according to an embodiment of the present subject matter; and

FIG. 6 is a flowchart of an example of an implementation of a method of operating the computer system according to an embodiment of the present subject matter.

### DETAILED DESCRIPTION

It should be noted that conception of the present subject matter resulted from recognition of certain limitations associated with service trap and trace processing. For example, it was observed that when a service programmer is investigating a problem, it is often the case that the available documentation showing the symptoms is insufficient to resolve the problem. It was recognized that, in some circumstances, an option is to write a service trap that fires when a particular system state that is thought to be characteristic of the error state is detected. When the trap fires, a system dump of all of the internal storage is taken, which will contain the internal trace table. The internal trace table may then be formatted out for analysis. In the case of customer information control system (CICS®), a customizable trap is available to service programmers called DFHTRAP, which is driven whenever CICS® makes a trace entry. The DFHTRAP may inspect the current trace entry and only continue processing for certain types of trace. It was further observed that running the trap code carries a performance overhead that may be significant in some cases. For example, it was observed that the trap may have to run a large chain of control blocks, performing tests on each control block, and that these tests themselves may be processor intensive. It was determined that, for this reason, the trap cannot run too frequently. However, it was also determined that if the trap runs too infrequently, then the internal trace record may not go back far enough in time to catch the root cause of the problem, as the trace table will have wrapped around and overwritten the oldest trace entries. As such, it was determined that the service programmer has to limit the frequency with which the trap runs by some means. It was determined that for CICS® systems, the service programmer may restrict the trap so that it only runs when certain types of trace entries are written. However, it was also observed that the frequency with which these specific trace entries are written is variable, dependent on the nature of the workload. It was determined that this is an indirect and inaccurate method of controlling how often the DFHTRAP runs. It was observed that in order to maximize the chance of catching the problem in the internal trace table, the service programmer will generally design the trap so that it runs more frequently than is really necessary. However, it was determined that the fact that the DFHTRAP must run more frequently than is really necessary, the additional execution increases the CPU requirements and cost to the customer. It was further determined that there is currently no means of optimizing the frequency with which the trap runs to minimize the performance impact on the customer's (possible production) system while still ensuring the internal trace will go back far enough to show the problem. The present subject matter improves service trap and trace processing.

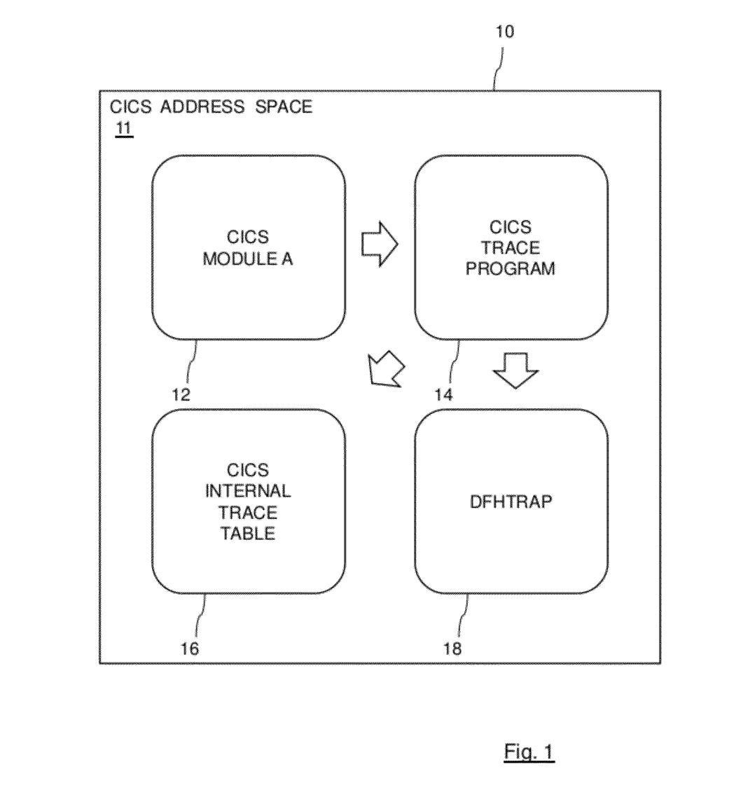

FIG. 1 is a schematic diagram of an example of an implementation of a computer system capable of performing operations according to the present subject matter. A computer system 10 is shown in FIG. 1 (CPU, etc. not shown for ease of illustration). An address space 11 is comprised of numerous different components, some of which may be programs being run or modules being called by other programs, or memory that may be written to and read from. Four such example components are shown in FIG. 1, being a module A 12, a trace program 14, an internal trace table 16, and a software trap (DFHTRAP) 18. The module A 12 may be one of a very large number of such modules that comprise the overall production system that is being delivered by the computer system 10. CICS® is a transaction manager designed for rapid, high-volume online processing, and may be used by financial institutions, for example.

Within the code that defines the module A 12, there are specific triggers that will lead to the creation of a trace entry. These triggers are part of the module A 12 when it is originally created, and a trace entry may be generated every time the module A 12 is accessed, for example. The trace entry may contain certain information relating to the triggering event and the module A 12, and so on. The module A 12 communicates with the trace program 14, which writes trace data to the internal trace table 16. The internal trace table 16 has a fixed size, and when the internal trace table 16 is full, the writing wraps around and overwrites the oldest trace entry.

The software trap 18 is a specific type of program that is designed to assist in error detection within such complex systems, such as the computer system 10. The software trap 18 may be called by the trace program 14 based upon the nature of the trace entry that is triggering the creation of trace data in the internal trace table 16. If the software trap 18 should run for a specific trace point identifier (ID) and the error state is detected by the software trap 18, then a dump of the CICS® address space storage is taken, including the internal trace table 16. The dump caused by the trap firing is designed to capture relevant trace data within the internal trace table 16.

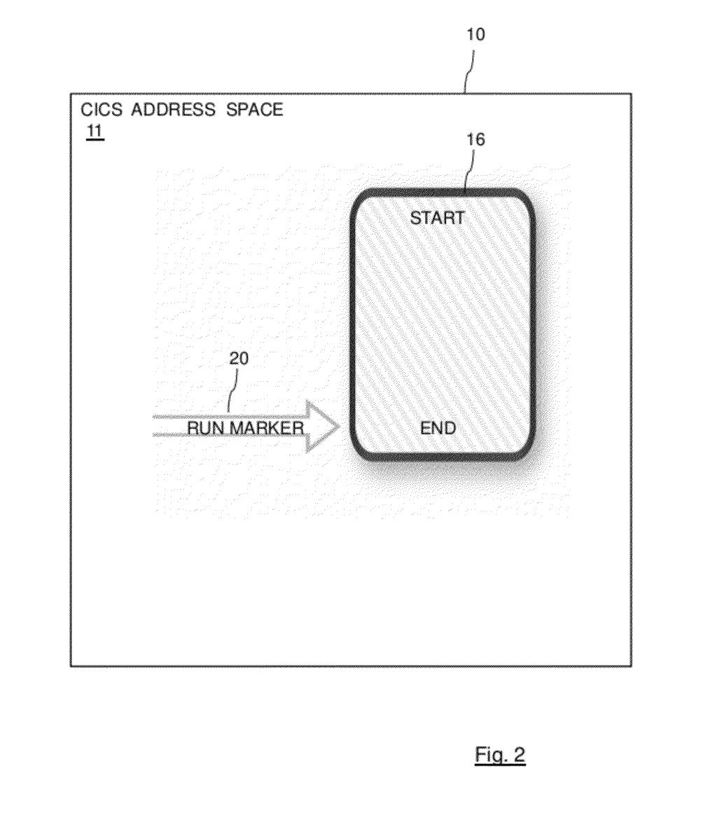

The improved computing system 10 for handling the running of the software trap 18 is shown in detail in FIGS. 2 to 6. FIG. 2 is a schematic diagram of an example of an implementation of the computer system of FIG. 1 showing use of a run marker. FIG. 2 shows the internal trace table 16, which is additionally provided with a run marker 20. Assuming that the computer system 10 is to be restarted and run to detect an error situation, then the internal trace table 16 will initially be empty of trace data, and the run marker 20 may be positioned at the end of the internal trace table 16. The size of the internal trace table 16 is fixed, but this size may be set by a suitably qualified user or administrator appropriate to the current production conditions.

The running of the software trap 18 is controlled by the position of the run marker 20. As described above, it was observed with respect to existing software systems, that a software trap is controlled by a trace program, depending upon the nature of a specific trace entry being written to a trace table. As described above, it was also determined that the problem with this approach is that the software trap either runs too frequently, absorbing system resources or does not run frequently enough, in which case the vital trace data that actually relates to the problem being detected by the software trap has been overwritten, as the cyclic writing to the trace table overwrites the oldest data in the table.

In contrast, according to the present subject matter, the software trap 18 is deliberately written to detect a specific state that is believed (by the programmer of the software trap 18) to relate to an error in the running of the computer system 10. The software trap 18, when it runs, will look for a specific set of circumstances defined in the software trap 18. This may be the existence of a specific set of flags, for example, or may relate to contents of particular memory addresses, and so on. If the software trap 18 does detect the set of circumstances that it is designed to detect, then the trap “fires.” The firing of the software trap 18 will cause the dump of the address space 11 to external storage.

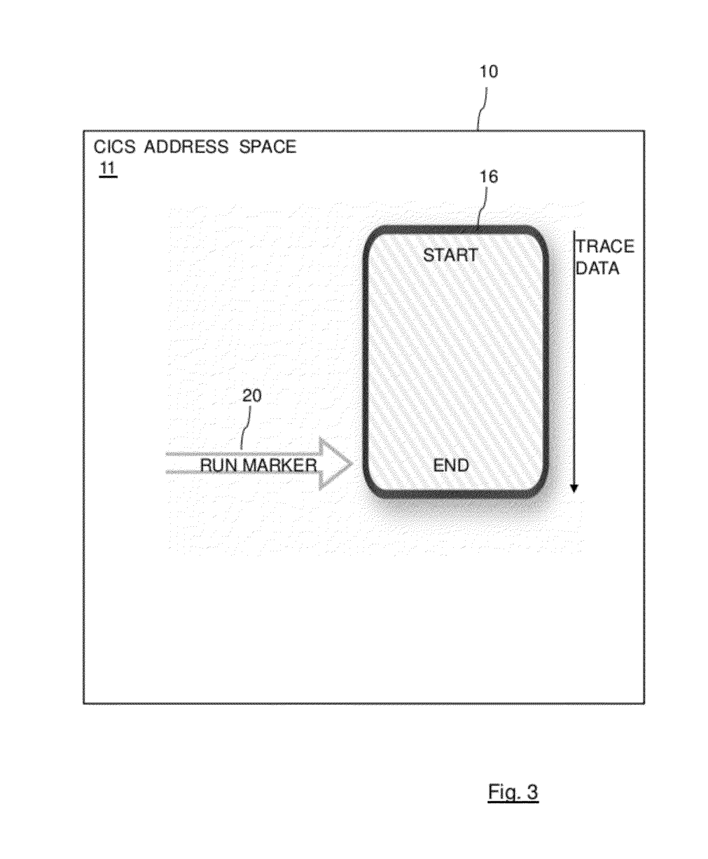

FIG. 3 is a schematic diagram of an example of an implementation of the computer system of FIG. 1 showing the writing of trace data to the internal trace table. Once the computer system 10 has been started, then as shown in FIG. 3, trace data will be written to the internal trace table 16. Trace data is generated by the module A 12 within the computer system 10, depending upon the configuration of the individual modules and programs that make up the overall production system. When the modules and programs are originally created, specific events relating to the individual modules and programs will trigger the creation of trace data, which will cause the writing of a trace entry in the internal trace table 16. Such an event may be the entry or exit of the module A 12, for example.

Each trace entry will be of a predetermined format and will have a series of fields that are populated by the trace program 14 in response to the event that triggered the creation of the trace data. Certain fields will be predetermined, such as a trace identifier (ID) and a timestamp, but other fields may be empty to be populated by data from the specific module A 12 that generated the trace data in the first place. Information about the specific circumstance surrounding the creation of the trace data is therefore captured in the trace entry and written to the internal trace table 16. This trace data in the internal trace table 16 may be accessed for diagnostic purposes.

When the trace table 16 is full, the software trap 18 will run. If the “error state” is detected, then the software trap 18 fires and dumps the address space 11 to an external storage device. Therefore, once the internal trace table 16 is full, then the run marker 20 has been reached, as this was set at the end of the internal trace table 16. This causes the software trap 18 to run, which then checks to see if the various flags and conditions programmed into the software trap 18 have been met. If they have been met, then the software trap 18 fires, and the contents of the address space 11 (which includes the internal trace table 16) are copied to the external storage.

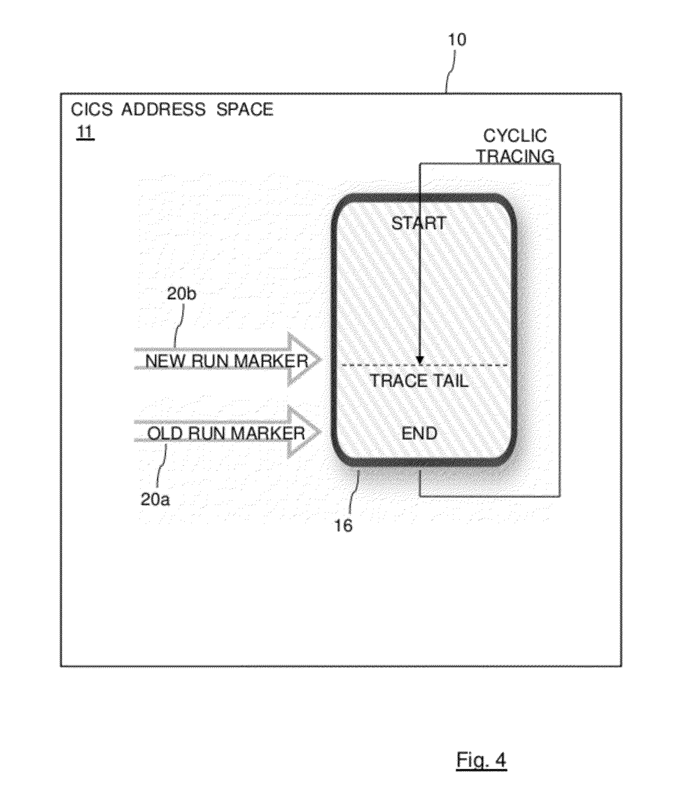

FIG. 4 is a schematic diagram of an example of an implementation of the computer system of FIG. 1 showing the use of a second run marker. If the software trap 18 described above did not fire on the first run, the run marker 20 is moved back in the internal trace table 16 a distance dependent on the value of a “trace tail,” as shown in FIG. 4. Tracing continues from the previous position of the run marker 20 (identified as an old run marker 20a in FIG. 4), until the new position of a new run marker 20b is reached. Tracing data is continued to be written to the internal trace table 16 and when the new run marker 20b in the internal trace table 16 has been reached, the software trap 18 runs again. In this example, the trace tail (new run marker 20b) has been set to twenty five percent (25%) of the overall trace table size behind the old run marker 20a.

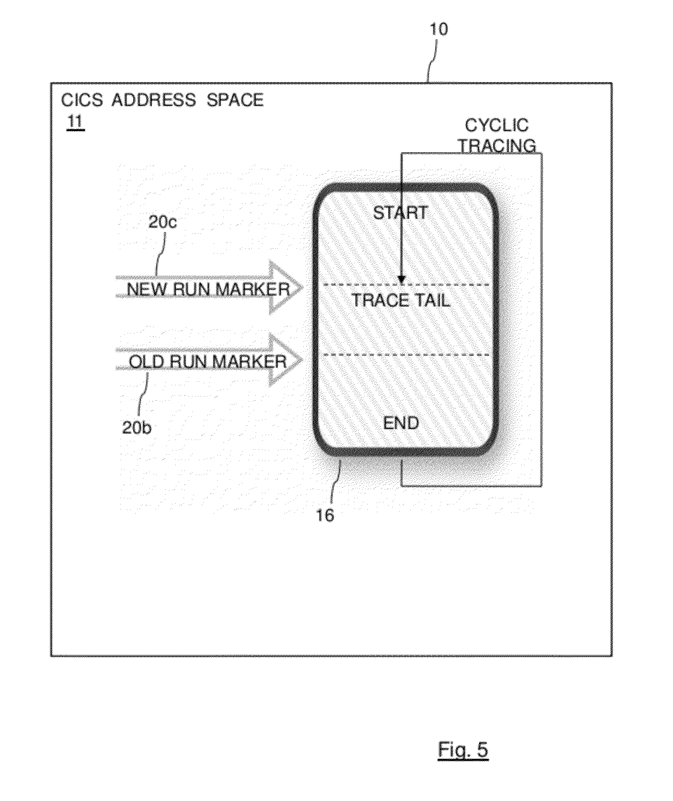

FIG. 5 is a schematic diagram of an example of an implementation of the computer system of FIG. 1 showing the use of a further run marker. As described above in association with FIG. 4, on the first invocation, the software trap 18 runs when the internal trace table 16 is full. After the software trap 18 has run (presuming it was not triggered) the previous new run marker 20b of FIG. 4 (now designated as an old run marker 20b) is set twenty five percent (25%) back (behind the previous old run marker 20a) in the internal trace table 16 and trace entries are written again from the previous old run marker 20a, which in this first case is the end of the internal trace table 16. With reference to FIG. 5, tracing continues until a new run marker 20c is reached, at which point the software trap 18 runs again. As shown in FIG. 5, after the software trap 18 has run (presuming it did not fire) the new run marker 20c is set further back (again twenty five percent, 25%, behind the old run marker 20b per the present example) in the internal trace table 16, and tracing continues from the old run marker 20b.

This method of processing ensures that even in the worst case scenario, when the error state is reached on the next trace entry after the software trap 18 has run, the internal trace table 16 will still contain the entries leading up to the error state, the number of these entries being dependent on the chosen trace tail length and the trace table size. The frequency with which the software trap 18 runs will be dependent on the size of the internal trace table 16 and the chosen trace tail size, both of which may be controlled by the user. The example trace tail of twenty five percent (25%) ensures that at least one quarter of the entries in the internal trace table 16 are relevant to the detected error state, as these have not been overwritten since the last time the software trap 18 ran.

A trace tail of zero means there will be zero or more trace entries in the internal trace table 16 showing the system activity leading up to the error state, so in the worst case when the error state is reached immediately after the software trap 18 has run, there will be no such trace entries. In such a situation, a service programmer may analyze the system activity leading up to the error state, but would not be able to do so if the earliest trace entry available in the dump is the entry that is written at the time the error state occurred. A larger trace tail (such as the example twenty five percent (25%) described above) would ensure that at least twenty five percent (25%) of the internal trace will include entries showing the activity leading up to the error state.

The error state is the state data the software trap 18 is testing for to indicate the occurrence of the problem under investigation. When the error state is detected, the software trap 18 will be triggered and will collect a system dump of internal storage, including the internal trace table 16. The trace tail is the percentage of the available internal trace table 16 not to be overwritten between runs of the software trap 18. The trace tail controls the minimum number of trace entries leading up to the error state that will be present in the internal trace table 16. The larger the trace tail the more often the software trap 18 will have to run.

The run marker 20 is a dynamic marker in the internal trace table 16 that causes the software trap 18 code to run. When the run marker 20 has been reached and the software trap 18 code has run, the run marker 20 is moved back in the internal trace table 16 by a distance equivalent to the trace tail (whether this is an absolute distance or a percentage distance), and tracing resumes at the previous position of the run marker 20. This ensures a balanced use of resources in the computing system 10, but also ensures that when the software trap 18 does run and fire, there will always be some trace data captured in the internal trace table 16 that is relevant to the detected error state.

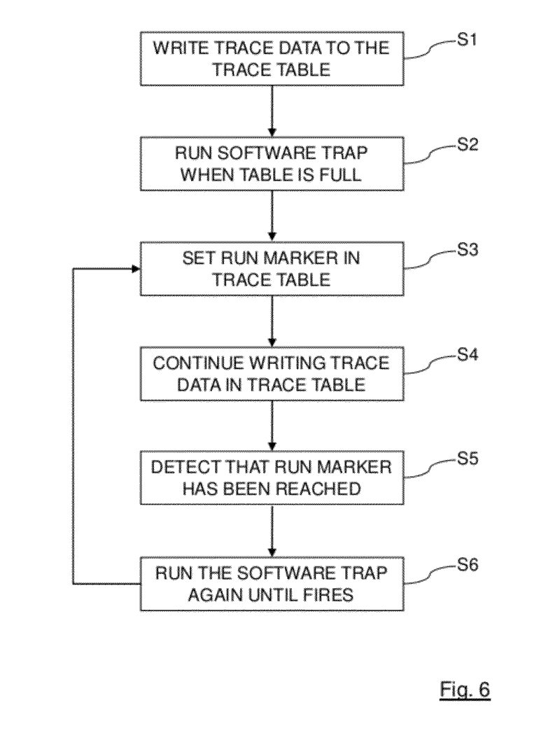

FIG. 6 is a flowchart of an example of an implementation of a method of operating the computer system according to an embodiment of the present subject matter. The method of operating the computer system is summarized in FIG. 6. The method comprises the steps of, step S1, periodically writing trace data to the trace table, step S2, running the software trap (a first time when the trace table is full), step S3, if the software trap does not fire, setting the run marker a predefined distance higher up the trace table, step S4, periodically writing trace data to the trace table, if necessary overwriting the earliest written trace table data, step S5, detecting that the most recently written trace data has reached the run marker, and finally, step S6, running the software trap again.

Based upon the present subject matter, it is possible to minimize the frequency with which a diagnostic trap runs and thus reduce performance overhead, while ensuring that the internal trace record will always cover the period leading up to the error state which triggered the trap. This optimization of the run time frequency is not available by any other means. The software trap is effectively triggered when the writing of the trace data to the trace table has reached the position of the run marker, which was set the last/previous time the software trap was run. As long as the software trap does not fire, this process is repeated. The methodology provides an efficient balance between the need to run the software trap as little as possible, with the benefit that when the software trap does run and fire, then the relevant trace data is available.

Preferably, the predefined distance at which the run marker is set higher up (behind a position of an old run marker) in the trace table comprises a predefined percentage of the size of the trace table. By setting the new position of the run marker using a percentage (for example twenty five percent (25%)) of the overall trace table size, an effective trigger for the next running of the software trap is created that will work efficiently no matter how much or how little address space storage has been assigned to the trace table. The percentage figure is the guaranteed amount of the trace table that will not have been overwritten since the last time that the software trap was run. This will ensure that sufficient relevant trace data is available, should the software trap fire. This method of setting the new position of the run marker uses a relative measure (e.g., the percentage) to determine the new position of the run marker, but alternatively an absolute measure, such as 10000 trace entries, may be used to move back the run marker.

Advantageously, the present subject matter involves running the software trap for the first time after detecting that the trace table is full. To delay the running of the software trap as long as possible (as the running of the trap will consume system resources), it is advantageous to wait for the trace table to fill before the software trap is run for the first time. If the trap fires, the entire contents of the trace table will be captured in the system dump that follows, and there will be a trace record available relevant to the error being tracked by the software trap that is as large as possible.

The present subject matter further involves receiving user input defining the size of the trace table and the predefined distance behind and relative to a present run marker at which the new run marker is set. An administrator or suitably accredited user may manage the process by setting the size of the trace table and the position of the run marker when it is reset. These two factors balance the consumption of system resources against the amount of trace data that will be available and relevant when the software trap is run and fires. Increasing the size of the trace table will allow more trace data to be available after a system dump, but will use more address space storage. Increasing the predefined distance at the which the run marker is set back/behind the present run marker to trigger the next running of the software trap will increase the amount of trace data that is relevant within the trace table after it is caught in the system dump, but will increase the frequency that the software trap is actually run, again increasing the use of system resources.

Preferably, the present subject matter involves repeating the steps of setting a new run marker, writing trace data to the trace table, detecting that the run marker has been reached, and running the software trap, until the software trap fires. The process of setting the new position for the run marker may be continued indefinitely until the software trap runs and fires. Each time the software trap is run but not fired, then the run marker is moved backwards to its new position and the software system will continue to operate writing trace data to the trace table until the new position of the run marker is reached. The software trap then runs again, and if it does not fire, then the process is repeated.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as JAVA™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable storage medium that can direct a computer or other programmable data processing apparatus to function in a particular manner, such that the instructions stored in the computer-readable storage medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method of operating a computer system comprising:
periodically writing trace data to a trace table;
running a software trap;
if the software trap does not fire, setting a run marker a predefined distance behind a position of an old run marker in the trace table;
periodically writing the trace data to the trace table, if necessary overwriting earlier written trace table data;
detecting that most recently written trace data has reached the run marker; and
running the software trap.

2. The method of claim 1, where the predefined distance at which the run marker is set behind the position of the old run marker in the trace table comprises a predefined percentage of a size of the trace table.

3. The method of claim 1, further comprising running the software trap for a first time after detecting that the trace table is full.

4. The method of claim 1, further comprising receiving user input defining a size of the trace table and the predefined distance at which the run marker is set.

5. The method of claim 1, further comprising repeating the steps of setting a new run marker, writing the trace data to the trace table, detecting that the run marker has been reached, and running the software trap, until the software trap fires.

6. A computer system comprising:
a trace table and a software trap; and
a processor programmed to:
periodically write trace data to the trace table;
run the software trap;
if the software trap does not fire, set a run marker a predefined distance behind a position of an old run marker in the trace table;
periodically write the trace data to the trace table, if necessary overwriting earlier written trace table data;
detect that most recently written trace data has reached the run marker; and
run the software trap.

7. The computer system of claim 6, where the predefined distance at which the run marker is set behind the position of the old run marker in the trace table comprises a predefined percentage of a size of the trace table.

8. The computer system of claim 6, where the processor is further programmed to run the software trap for a first time after detecting that the trace table is full.

9. The computer system of claim 6, where the processor is further programmed to receive user input defining a size of the trace table and the predefined distance at which the run marker is set.

10. The computer system of claim 6, where the processor is further programmed to repeat the operations of setting a new run marker, writing the trace data to the trace table, detecting that the run marker has been reached, and running the software trap, until the software trap fires.

11. A computer program product comprising a computer readable storage medium including computer readable program code, where the computer readable program code when executed on a computer causes the computer to:
periodically write trace data to a trace table;
run a software trap;
if the software trap does not fire, set a run marker a predefined distance behind a position of an old run marker in the trace table;
periodically write the trace data to the trace table, if necessary overwriting earlier written trace table data;
detect that most recently written trace data has reached the run marker; and
run the software trap.

12. The computer program product of claim 11, where the predefined distance at which the run marker is set behind the position of the old run marker in the trace table comprises a predefined percentage of a size of the trace table.

13. The computer program product of claim 11, where the computer readable program code when executed on the computer further causes the computer to run the software trap for a first time after detecting that the trace table is full.

14. The computer program product of claim 11, where the computer readable program code when executed on the computer further causes the computer to receive user input defining a size of the trace table and the predefined distance at which the run marker is set.

15. The computer program product of claim 11, where the computer readable program code when executed on the computer further causes the computer to repeat the operations of setting a new run marker, writing the trace data to the trace table, detecting that the run marker has been reached, and running the software trap, until the software trap fires.
